(19) United States
(12) Patent Application Publication
(10) Pub. No.: US 2014/0191151 A1
(43) Pub. Date: Jul. 10, 2014

(54) SOLIDS-HANDLING EQUIPMENT

(71) Applicants: Paul Smit Baumann, Johannesburg (ZA); Daniel Francis, Johannesburg (ZA)

(72) Inventors: Paul Smit Baumann, Johannesburg (ZA); Daniel Francis, Johannesburg (ZA)

(73) Assignee: SASOL TECHNOLOGY (PROPRIETARY) LIMITED, Johannesburg (ZA)

(21) Appl. No.: 14/234,821

(22) PCT Filed: Jun. 27, 2012
(86) PCT No.: PCT/IB2012/053252

§ 371 Date: Jan. 24, 2014

(30) Foreign Application Priority Data
Jul. 26, 2011 (GB) 1112885.7

(51) Int. Cl. F16K 1/46

(52) U.S. Cl. CPC F16K 1/465
USPC 251/359

(57) ABSTRACT

A seat component (17) for solids-handling equipment includes a metal seat body (32) defining an endless hardened metal seat surface (40) for a closure component (16) to seat against with metal-to-metal contact and with a solids flow path extending through the seat body (32). The seat body (32) includes an endless recess (50) spaced radially outwardly from the hardened metal seat surface (40), which has a mouth (52) and an interior (54) communicating with the mouth (52) and extending away from the mouth (52) into the seat body (32). The interior (54) of the recess (50) has at least one region (56) which is wider than the mouth (52) or which is wider than a narrower region of the recess (50) between the wider region (56) and the mouth (52). The wider region (56) is defined by at least one step-wise change in the width of the recess (50). An endless seal (70) of an elastic material defines at least one retention formation (72) caught or located in the wider region (56) behind the step-wise change in the width of the recess (50) to inhibit displacement of the seal (70) out of the recess (50). Sides (78, 80) of a portion of the seal (70) outside the recess (50) are both slanted at an angle to a stroke axis of the seat body (32) or the closure component (16), and the spacing of the endless recess (50) from the hardened metal seat surface (40) provides room for the seal (70) to be compressed into without preventing metal-to-metal seating of the closure component (16) against the hardened metal seat surface (40).

THIS INVENTION relates to solids-handling equipment. In particular, the invention relates to a seat component for solids-handling equipment, and to a solids-handling closure assembly.

For some solids-handling equipment, such as the Sasol® FBDB™ gasifier, it is necessary intermittently or continuously to load and unload particulate material, such as particular carbonaceous material (e.g. coal) and ash. Thus, for example, in the case of a pressurized gasifier (e.g. a fixed bed dry bottom gasifier), particulate carbonaceous feedstock is loaded into the operating gasifier, and gasified at elevated temperatures and pressures, and after gasification any remaining ungasified material is removed from the gasifier as ash via an ash lock.

In order to feed carbonaceous material to the gasifier while operating, a so-called coal lock is filled batchwise at atmospheric pressure with the carbonaceous feed material. A carbonaceous feed material top flow path of the coal lock is sealed off using a coal lock top valve assembly (i.e. a so-called coal lock top cone and seat assembly which provides a seal) and thereafter pressurized with raw synthesis gas from the gasifier or another pressurization medium e.g. CO₂ up to the operating pressure of the gasifier. Once the coal lock is at the operating pressure of the gasifier, a bottom flow path of the coal lock is opened by means of a bottom valve assembly (a so-called coal lock bottom cone and seat assembly) and the carbonaceous material is fed into the gasifier under gravity. After emptying the coal lock, the bottom flow path is closed again by means of the bottom valve assembly and the coal lock is depressurized, whereafter the carbonaceous feed material loading procedure is repeated.

To ensure the continuing and safe operation of a pressurized gasifier during the unloading of the coal lock into the gasifier, it is important that a pressure seal is maintained between the pressurized coal lock and the atmosphere. In the current state of the art this is achieved with said coal lock top valve assembly, which is essentially a valve assembly or solids-handling closure assembly, comprising of two primary sub-assemblies or assembled components, namely a closure component (typically a conical valve closure body or cone) for closing off a solids flow path, and a separate seat component or body defining a seat for the closure component and defining said flow path. The seat component or body typically remains stationary while the closure component is hydraulically actuated (typically up and down in a vertical plane) between open and closed conditions, along a common centre line of the closure component and the seat component or body. Apart from providing a pressure seal when in the closed condition when a differential pressure is present across the valve assembly, the valve assembly also serves to control material flow through the valve assembly, into the coal lock.

In the prior art, the seat body typically comprises a single, circular metal forging provided with an annular machined groove around an inner bore thereof into which a rubber sealing element or rubber ring is fitted. A radially interior edge of the seat body is provided with a hardened surface to provide a seat surface for the closure component.

The closure component typically comprises a flat, disc-shaped forging of a diameter larger than the seat bore, connected to a tie rod which serves as a linkage to a hydraulic actuation system. An outer periphery of the disc-shaped forging is chamfered and the chamfered surface is hardened. When the closure component is actuated from an open condition to a closed condition, a pressure seal is created firstly by the compression of the rubber ring between the closure component and the seat body and shortly thereafter by the metal-to-metal contact between the hardened edge of the closure component and the hardened edge of the seat body.

With the prior art valve assembly, occasions arise where the pressure seal cannot be maintained due to gas leakage through the valve assembly. In extreme cases, this results in shutdown of the equipment (e.g. a pressurised gasifier) which is clearly undesirable as it may severely impact on production levels and income generated from the equipment. The leaking gas is also highly flammable in the case of a gasifier and can lead to unsafe conditions. The prior art design thus results in inefficient operation and reduction or mitigation of this inefficiency would be beneficial.

Investigations have revealed that the development of a leak path between the closure component and the rubber ring is partly due to problems associated with the design of the seat body and with the design of the rubber ring. It has been found that retention of the rubber ring in the seat body is poor, with the rubber ring prying loose after short service intervals. Replacement of the rubber ring in situ is a difficult and potentially hazardous activity and field-installed rings have a shorter life expectancy than rings installed under controlled shop conditions. Furthermore, the overall system has very little redundancy. When the rubber ring is damaged, the compression seal provided by the rubber seal is compromised and the metal-to-metal seat has limited sealing effectiveness, due to fine material collecting between the hardened sealing surfaces of the seat body and the closure component. The rubber ring is more accommodating of fine material as the deformation of the ring under compression allows for the inclusion of some fine material on a sealing interface between the rubber ring and the closure component.

The inventors are also aware of conventional valves (GB 199672), conventional taps and faucets (U.S. Pat. No.4,836,500), slide-shaped closure members (U.S. Pat. No. 5,732,727) and butterfly valves (U.S. Pat. No. 4,006,883) used in fluid service (i.e. liquid or gas service) and employing a single seal to provide a pressure tight seal across a fluid flow path. None of these valves is suitable for handling solids flow.

GB 199672 deals with conventional valves in fluid service, and teaches a novel method of securing a metal seating ring to a valve or a valve body to obtain a better holding effect of the metal seating ring. More particularly, GB 199672 deals with a double flange-design valve or valve body which is used to clamp a metal seating ring in place by rolling one of the flange members over the metal seating ring. The metal seating ring is thus permanently clamped in the recess provided between the two flanges on the valve or valve body.

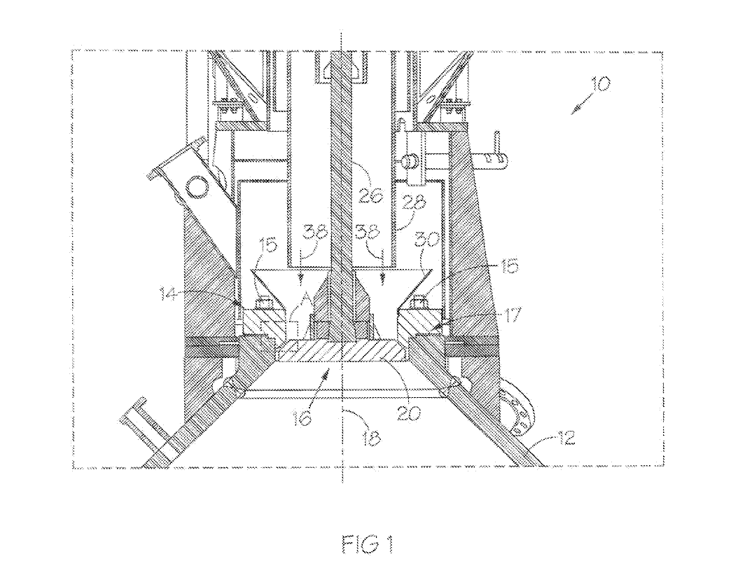

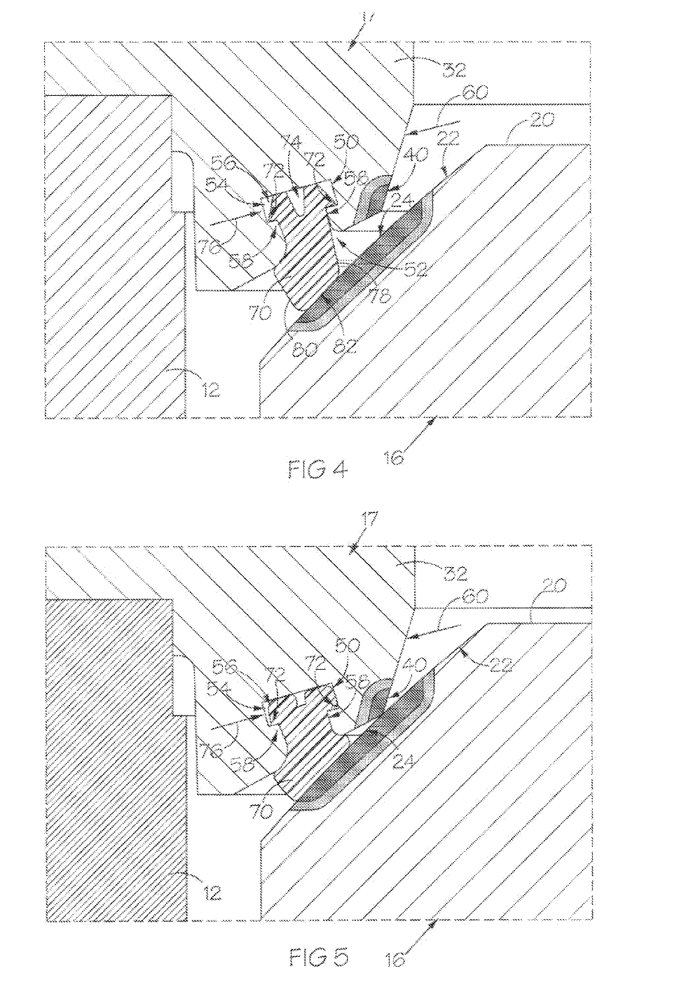

U.S. Pat. No. 5,732,727 deals with sealing members used in slide-shaped (i.e. piston) closure members (i.e. valves) in fluid service. In the preferred embodiment of U.S. Pat. No. 5,732,727 the radial sealing means are supported and protected by a circumferential wall both when the valve is in the closed position and when the valve is in the open position. In the closed position (as shown in FIG. 1 of U.S. Pat. No.5,732,727) the seal is maintained by a rubber-to-metal seal. In the open position (as shown in FIG. 4 of U.S. Pat. No. 5,732,727), the seal is maintained by a rubber-to-rubber seal. The seal 2* or 2,2* of U.S. Pat. No. 5,732,727 is located in a seat body 4. The valve is described in U.S. Pat. No. 5,732,727 as a double-seat valve since the sealing member abuts against one of two different seats depending on whether the valve is in the open position or the closed position. During transition, the sealing member abuts against both seats at some stage.

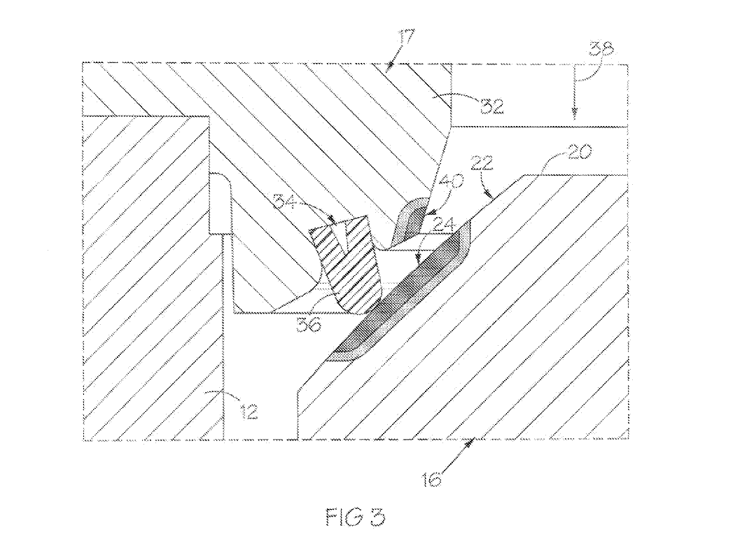

U.S. Pat. No. 4,836,500 makes reference to a prior art design (shown in FIG. 3 of U.S. Pat. No. 4,836,500) wherein a seal ring is confined in an undercut circumferential groove. The seal is provided with a pair of longitudinal shoulders which are engagable with opposing flanges in the undercut circumferential groove. The seal ring is further provided with a secondary “O-ring” provided to eliminate any leak path between the seal ring and the recess in which it is retained. U.S. Pat. No. 4,836,500 thereafter goes on to deal with the disadvantages of such a design and proposes a new design for an assembly for retaining a seal ring and the associated O-ring in a seating surface of a valve. The novel assembly includes a first circumferential groove in the seating surface for receiving the seal ring and a second circumferential slot for receiving a retaining element. The design of U.S. Pat. No. 4,836,500 is applicable to conventional faucets and butterfly valves operating in fluid service and relates in particular to seal rings made of a resilient material.

U.S. Pat. No. 4,006,883 deals with an adjustable seat for a butterfly valve. One side of a sealing member of a resilient material is located in an annular groove having a single undercut shoulder. A plurality of circumferentially spaced an inwardly directed retaining members are provided which abut against a second side of the sealing member. Adjustment means act against the retaining members thereby to adjust the sealing pressure of the sealing member.

According to one aspect of the invention, there is provided a seat component for solids-handling equipment, the seat component including
a metal seat body defining an endless hardened metal seat surface for a closure component to seat against with metal-to-metal contact and with a solids flow path extending through the seat body, the endless hardened metal seat surface circumnavigating or extending around a stroke axis along which at least one of the seat body and said closure component are displaceable in use to open and close said solids flow path extending through the seat body, the seat body including an endless recess spaced radially outwardly from the hardened metal seat surface relative to the stroke axis so that the hardened metal seat surface is closer to the stroke axis than the recess and the recess having a mouth and an interior communicating with the mouth and extending away from the mouth into the seat body, the interior of the recess having at least one region which is wider than the mouth or which is wider than a narrower region of the recess between the wider region and the mouth, with the wider region being defined by at least one step-wise change in the width of the recess, where all widths are taken in a common plane extending radially away from the stroke axis and in a common direction or parallel directions transverse to the endless recess; and
an endless seal of an elastic material, a portion of the seal being located inside the recess and a portion of the seal extending outwards through the mouth of the recess, the portion of the seal inside the recess defining at least one retention formation caught in said wider region behind said step-wise change in the width of the recess to inhibit displacement of the seal out of the recess, a side of the portion of the seal outside the recess nearer the stroke axis and a side of the portion of the seal outside the recess remote from the stroke axis both being slanted at an angle to the stroke axis, or at an angle to the vertical, and the spacing of the endless recess from the hardened metal seat surface providing room for the seal to be compressed into without preventing metal-to-metal seating of said closure component against the hardened metal seat surface.

In this specification, the term “component” is intended to include an assembled component comprising more than one part, such as a seat component comprising at least a seat body and an endless seal.

When viewed in transverse cross-section, the recess thus widens in at least one region or narrows in at least one region so that there is a clearly recognisable region which is wider than the mouth, or there is a narrower region between the mouth and the wider region, to inhibit displacement of the seal from the recess by virtue of said at least one retention formation caught in the wider region behind the step-wise change in the width of the recess.

Typically, the flow path is circular in transverse cross-section and the closure component is configured to close the flow path by plugging the flow path. The endless seat surface is thus typically annular with the solids flow path being defined by a circular bore in the seat body. Similarly, the endless recess in the seat body is typically circular.

The step-wise change in the width of the recess may be provided by a pair of transversely opposed lips positioned between the wider region of the recess and the mouth of the recess. A portion of the seal, including said at least one retention formation, is then caught behind the lips, inside the wider region of the recess. The lips may be endless.

Said portion of the seal inside the recess may define a pair of retention formations, each retention formation being caught behind an associated one of the lips. The retention formations may be endless.

Said portion of the seal inside the recess may define a groove between the retention formations of the pair of retention formations to assist in forcing the retention formations closer together thereby to facilitate insertion of the retention formations into the recess.

The groove may be V-shaped in transverse cross-section.

The groove may extend into the seal in a direction towards the mouth. Preferably, the groove does not extend beyond the step-wise change in the width of the recess.

The groove may be endless.

The seat surface of the seat body may be closer to the stroke axis than the recess. The seat surface may be spaced from the recess providing room for the seal to be compressed into without preventing direct or metal-to-metal seating of the closure component against the seat surface.

The seat surface may be defined by an annular zone of the seat body which is hardened relative to the rest of the seat body.

The seal may be shaped such that said portion of the seal extending outward through the mouth widens in transverse cross-section outside the mouth.

As will be appreciated, the seal in use typically separates a higher pressure environment from a lower pressure environment. The seal may widen in a direction towards or into a zone which in use will represent the higher pressure environment.

The seal may widen in a direction away from the endless seat surface, where the width is taken as hereinbefore described. In other words, the seal may widen in a direction extending outwardly away from the stroke axis.

A side of the portion of the seal outside the recess nearer the stroke axis and a side of the portion of the seal outside the recess remote from the stroke axis are thus both slanted at an angle to the stroke axis, or at an angle to the vertical. Preferably, the side of the seal remote from the stroke axis slants more relative to the stroke axis than the side of the seal nearer the stroke axis.

The seal may define a seal surface remote from the seat body for contacting the closure component in use when the flow path is closed, said seal surface being complemental to a frusto-conical surface. In other words, the seal may be bevelled or truncated to define an annular slanted seal surface that may fit snugly over or against a frusto-conical body.

According to another aspect of the invention, there is provided a solids-handling closure assembly which includes
a closure component displaceable between a closed condition and an open condition to close or open a solids flow path; and
a seat component providing a seat surface for the closure component when in the closed condition, wherein the seat component is a seat component as hereinbefore described.

The closure component may include a metal closure body defining a substantially frusto-conical surface to contact the seal and the seat surface of the seat component when the closure component is in said closed condition. An annular region of the frusto-conical surface may be hardened relative to the rest of the closure body for seating against the seat of the seat component.

The slant angle of the frusto-conical surface of the closure body may be the same as an angle which said seal surface remote from the seat body forms with the horizontal, when the stroke axis is arranged vertically. In other words, when the closure assembly is viewed in a vertical section, the annular slanted seal surface of the seal may be parallel to the frusto-conical surface of the closure body so that the seal surface fits snugly over or against the frusto-conical surface of the closure body.

Typically, the solids-handling closure assembly includes an actuator connected to the closure component, the actuator extending along the solids flow path and passing through the seat component.

The solids-handling closure assembly may form part of a pressurized gasifier for gasification of particulate carbonaceous material, e.g. a fixed bed dry bottom gasifier. In particular, the solids-handling closure assembly may form part of a carbonaceous feed material coal lock valve assembly of a pressurized gasifier. In principle, the solids-handling closure assembly can also be employed as a feedstock closure mechanism for other pressurized equipment or vessels handling solids material at elevated temperatures and pressures, in particular equipment handling wet or abrasive solids materials, e.g. combustion apparatus, pyrolysis apparatus, fluidised bed gasification apparatus, food processing apparatus and bulk material handling equipment for agricultural products or ore beneficiation.

The invention will now be described by way of example with reference to the accompanying diagrammatic drawings in which

FIG. 1 shows a vertically-sectioned side view of a portion of a coal feeder system of a pressurized gasifier, including a solids-handling closure assembly in a closed condition;

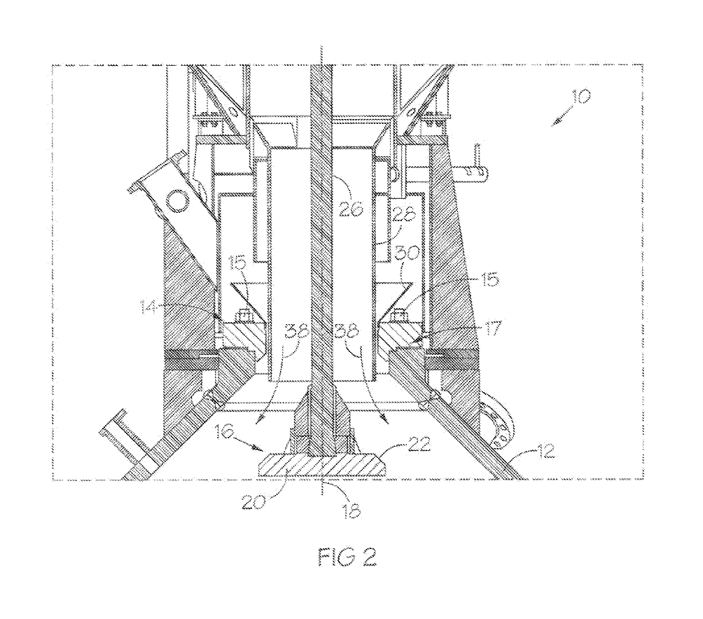

FIG. 2 shows the closure assembly illustrated in FIG. 1 in an open condition;

FIG. 3 shows the detail marked “A” in FIG. 1, where the solids-handling closure assembly includes a conventional seat component, with the solids-handling closure assembly in a partially open condition;

FIG. 4 shows the detail marked “A” in FIG. 1, where the seat component is a seat component in accordance with the invention and with the solids-handling closure assembly in a partially open condition; and

FIG. 5 shows the detail of FIG. 4 where the solids-handling closure assembly is in a fully closed condition.

Referring to FIG. 1 of the drawings, an upper portion of a coal feeder system generally indicated by reference numeral 10 is shown. The coal feeder system 10 is used with a pressurized gasifier, and in particular a fixed bed dry bottom gasifier (not shown). The coal feeder system 10 includes a vessel 12 (i.e. a coal lock) with a top inlet in which a solids-handling closure assembly 14 is located. The closure assembly 14 is bolted to a flange of the vessel 12 by means of bolts 15.

The closure assembly 14 includes a closure component 16 which is displaceable between a closed condition (as shown in FIG. 1) and an open condition (as shown in FIG. 2), along a stroke axis indicated by reference numeral 18. The closure component 16 includes a metal closure body 20 in the form of a relatively flat, disc-shaped forging.

As can be seen in FIG. 3 of the drawings, the closure body 20 has a chamfered periphery defining a substantially frusto-conical surface 22. An annular region 24 of the frusto-conical surface 22 is hardened relative to the rest of the closure body 20.

The closure body 20 is attached to a tie rod 26 which is typically hydraulically operated and by means of which the closure component can be displaced between its closed condition and its open condition as shown in FIGS. 1 and 2 respectively. A coal chute 28 is attached to the tie rod and moves with the tie rod up and down along the stroke axis 18. A coal spillage tray 30 forms part of the closure assembly 14. When the closure assembly is in a closed condition as shown in FIG. 1, the coal chute 28 is above the spillage tray 30 so that any coal spilled from the coal chute 28 is caught by the spillage tray 30. When the closure assembly 14 is in an open condition as shown in FIG. 2 however, the coal chute 28 drops down through the coal spillage tray 30 to deposit coal directly into the vessel 12.

The closure assembly 14 includes a seat component 17 which includes a metal seat body 32 which defines an endless seat surface for the closure component 16 to seat against. The seat body 32 is in the form of a single, circular metal forging provided in the prior art with an annular machined groove 34 as shown in FIG. 3 of the drawings. A rubber seal 36 forming part of the seat component 17 is fitted into the groove 34 and protrudes in a downwards direction from the groove 34.

The seat body 32 defines a solids flow path for coal, the solids flow path being generally indicated by arrows with the reference numeral 38. The solids flow path 38 is defined by a central circular bore of the seat body 32 with the stroke axis 18 passing centrally through the bore. A radially interior edge of the seat body 32 is provided with a hardened surface 40 and defines said endless seat surface for the closure component 16. As will thus be appreciated, the endless seat surface 40 circumnavigates or extends around the stroke axis 18.

In use, the coal feeder system 10 is employed intermittently to load coal into a fixed bed dry bottom gasifier. The closure assembly 14 is opened as shown in FIG. 2 with the coal chute 28 extending through the seat body 32 and the vessel 12 is filled batchwise at atmospheric pressure with the coal flowing through the chute 28 along the solids flow path 38. When the vessel 12 has been filled, the closure assembly 14 is closed as shown in FIG. 1 of the drawings and thereafter pressurized with raw synthesis gas from the gasifier or another suitable pressurization medium e.g. CO₂ up to the operating pressure of the gasifier. When the vessel 12 is at the operating pressure of the gasifier, a bottom flow path (not shown) of the vessel 12 is opened by means of a bottom valve assembly (not shown) and the coal is fed from the vessel 12 into the gasifier under gravity. After emptying the vessel 12, the bottom flow path is again closed by means of the bottom valve assembly and the vessel 12 is depressurized, whereafter the coal loading procedure is repeated.

During the closing action of the closure assembly 14, i.e. when the closure body 20 is displaced upwardly towards the seat component 17 by means of the tie rod 26, a pressure seal is firstly created by compression of the rubber seal 36 between the closure body 20 and the seat body 32 and shortly thereafter by the metal-to-metal contact between the annular hardened seat surface 40 and the annular hardened region 24.

With the prior art groove 34 and rubber seal 36 as shown in FIG. 3 of the drawings, occasions arise where a pressure seal cannot be maintained when the vessel 12 is pressurized, due to gas leakage through the closure assembly 14. Retention of the rubber seal 36 in the groove 34 is poor and the rubber seal 36 pries loose after short service intervals. When the rubber seal 36 is damaged, the compression seal provided by the rubber seal 36 is compromised and the metal-to-metal seal between the hardened seat surface 40 and the annular hardened region 24 has limited sealing effectiveness, due to fine material, i.e. coal particles, collecting between the surfaces 40, 24.

A closure assembly in accordance with the invention which includes an improved seat component 17 is shown in FIGS. 4 and 5 of the drawings. In FIGS. 4 and 5, the same reference numerals are used as are used in FIG. 3 to indicate the same or similar parts or features, unless otherwise indicated.

Unlike the machined groove 34, the metal seat body 32 of the closure assembly of the invention has an endless T-shaped annular recess 50 which has a mouth 52 and an interior 54 communicating with the mouth 52 and extending away from the mouth 52 into the seat body 32. The recess 50 has a region 56 which is wider than the mouth 52 and which is defined by a pair of stepwise changes in the width of the recess 50 with the stepwise changes in turn being provided by a pair of transversely opposed lips 58 positioned between the wider region 56 and the mouth 52. All widths are taken in directions parallel to the arrow indicated by reference numeral 60 and are thus taken in a common plane extending radially away from the stroke axis 18 and transverse to the recess 50.

In the closure assembly of the invention, it is not only the recess 50 which is different from the groove 34. A rubber seal 70 is employed in the closure assembly of the invention which looks substantially different from the rubber seal 36.

A portion of the rubber seal 70 located inside the recess 50 defines a pair of retention formations 72 which are caught in said wider region 56 behind the lips 58. The retention formations 72 in cooperation with the lips 58 inhibit displacement of the rubber seal 70 out of the recess 50. The retention formations 72 are also defined by stepwise changes in the width of the rubber seal 70, providing the rubber seal 70 with a pair of shoulders functioning as retention formations 72.

An endless V-shaped groove 74 is positioned centrally between the retention formations 72 and extends in the direction of the mouth 52 of the recess 50, i.e. perpendicular to the direction 60 in which all widths are taken. The groove 74 does not extend beyond the lips 58 as can be seen in FIG. 4.

As can be seen in FIG. 4 of the drawings, a portion of the seal 70 externally of the recess 50 widens in transverse cross-section in a direction away from the seat surface 40, i.e. substantially in the direction indicated by arrow 60. A side 78 of said portion of the seal 70 outside the recess 50 and a side 80 of said portion of the seal 70 outside the recess 50 are slanted at an angle to the stroke axis 18, i.e. to the vertical. The side 80 slants more relative to the stroke axis 18 than the side 78.

The seal 70 defines a seal surface 82 for contacting the closure body 20 during closing of the closure assembly of the invention and when the closure component 16 is in its closed condition as shown in FIG. 5 of the drawings. The seal surface 82 is complemental to the substantially frusto-conical surface 22 of the closure body 20 so that when the closure component 16 is displaced upwardly along the stroke axis 18, the seal surface 82 uniformly contacts the frusto-conical surface 22 of the closure body 20. In other words, when viewed in vertical section as shown in FIG. 4, the seal surface 82 is parallel to the substantially frusto-conical surface 22.

When the closure assembly of the invention is in a closed condition as shown in FIG. 5 of the drawings, the seal 70 partially fills a communicating volume between the seat body 32 and the closure body 20 on reaching a maximum point of compression which coincides with the metal-to-metal contact between the seat surface 40 and the annular hardened region 24. During subsequent pressurization of the vessel 12 (e.g. to a pressure of about 30 bar(g)), finite element analysis has shown that the seal 70 further expands to increase the contact stress between the seal 70 and the closure body 20 on the one hand, and between the seal 70 and the seat body 32 on the other hand. This provides an additional sealing mechanism through expansion of the seal 70 into the communicating volume between the bodies 20 and 32. Furthermore, as a result of the configuration of the recess 50 and the seal 70, retention of the seal 70 in the recess 50 is improved and occurrence of a leakage path between the seal 70 and the seat body 32 is virtually eliminated. The closure assembly of the invention, as illustrated, thus provides for a reduction in lost production due to greater availability of equipment, a reduction in operating costs due to reduction in maintenance required for the seal 70. Furthermore, advantageously minor modifications only are required to retrofit the solution provided by the invention to existing equipment. In other words, retrofitting of existing closure assemblies to obtain the advantages of the invention is thus achieved by means of relatively minor modifications to the existing equipment. Investigation has shown that this improved version is also less costly to fabricate than the current state of the art.

It must be appreciated that the seat component and closure assembly of the invention may find application also in carbonaceous feedstock (e.g. coal, carbonaceous waste, biomass or combinations hereof) beneficiation or upgrading plants, and potentially also in other pressurized equipment or vessels (e.g. operating at pressures of between 5 bar(g) and 100 bar(g)) handling solids material, particularly wet or abrasive solids material, e.g. combustion apparatus, pyrolysis apparatus, fluidised bed gasification apparatus, food processing apparatus and bulk material handling equipment for agricultural products or ore beneficiation.

1. A seat component for solids-handling equipment, the seat component including
a metal seat body defining an endless hardened metal seat surface for a closure component to seat against with metal-to-metal contact and with a solids flow path extending through the seat body, the endless hardened metal seat surface circumnavigating or extending around a stroke axis along which at least one of the seat body and said closure component are displaceable in use to open and close said solids flow path extending through the seat body, the seat body including an endless recess spaced radially outwardly from the hardened metal seat surface relative to the stroke axis so that the hardened metal seat surface is closer to the stroke axis than the recess and the recess having a mouth and an interior communicating with the mouth and extending away from the mouth into the seat body, the interior of the recess having at least one region which is wider than the mouth or which is wider than a narrower region of the recess between the wider region and the mouth, with the wider region being defined by at least one step-wise change in the width of the recess, where all widths are taken in a common plane extending radially away from the stroke axis and in a common direction or parallel directions transverse to the endless recess; and
an endless seal of an elastic material, a portion of the seal being located inside the recess and a portion of the seal extending outwards through the mouth of the recess, the portion of the seal inside the recess defining at least one retention formation caught in said wider region behind said step-wise change in the width of the recess to inhibit displacement of the seal out of the recess, a side of the portion of the seal outside the recess nearer the stroke axis and a side of the portion of the seal outside the recess remote from the stroke axis both being slanted at an angle to the stroke axis, or at an angle to the vertical, and the spacing of the endless recess from the hardened metal seat surface providing room for the seal to be compressed into without preventing metal-to-metal seating of said closure component against the hardened metal seat surface.

2. The seat component as claimed in claim 1, in which the step-wise change in the width of the recess is provided by a pair of transversely opposed lips positioned between the wider region of the recess and the mouth of the recess.

3. The seat component as claimed in claim 2, in which said portion of the seal inside the recess defines a pair of retention formations, each retention formation being caught behind an associated one of the lips.

4. The seat component as claimed in claim 3, in which said portion of the seal inside the recess defines a groove between the retention formations of the pair of retention formations to assist in forcing the retention formations closer together thereby to facilitate insertion of the retention formations into the recess, the groove extending into the seal in a direction towards the mouth and the groove not extending beyond the step-wise change in the width of the recess.

5. The seat component as claimed in any of claim 1, in which the seal is shaped such that said portion of the seal extending outward through the mouth widens in transverse cross-section outside the mouth.

6. The seat component as claimed in claim 5, in which the seal widens in a direction extending outwardly away from the stroke axis.

7. The seat component as claimed in any of claim 1, in which the side of the seal remote from the stroke axis slants more relative to the stroke axis than the side of the seal nearer the stroke axis.

8. The seat component as claimed in any of claim 1, in which the seal defines a seal surface remote from the seat body for contacting the closure component in use when the flow path is closed, said seal surface being complemental to a frusto-conical surface.

9. A solids-handling closure assembly which includes
a closure component displaceable between a closed condition and an open condition to close or open a solids flow path; and
a seat component providing a seat surface for the closure component when in the closed condition, wherein the seat component is a seat component as claimed in claim 1.

10. The solids-handling closure assembly of claim 9, in which the closure component includes a metal closure body defining a substantially frusto-conical surface to contact the seal and the seat surface of the seat component when the closure component is in said closed condition, and in which the seat component is a seat component as claimed in claim 8, and in which the slant angle of the frusto-conical surface of the closure component is the same as an angle which said seal surface remote from the seat body forms with the horizontal, when the stroke axis is arranged vertically.

11. The solids-handling closure assembly of claim 9, which forms part of a pressurized gasifier for gasification of particulate carbonaceous material.
